(19) United States
(12) Patent Application Publication
(10) Pub. No.: US 2026/0316203 A1
(43) Pub. Date: Oct. 15, 2026

(54) BIAXIAL ROTARY TABLE DEVICE AND MACHINE TOOL

(71) Applicant: FANUC CORPORATION, Minamitsuru-gun, Yamanashi-ken (JP)

(72) Inventor: Shingo TACHIKI, Minamitsuru-gun, Yamanashi-ken (JP)

(73) Assignee: FANUC CORPORATION, Minamitsuru-gun, Yamanashi-ken (JP)

(21) Appl. No.: 19/486,177

(22) PCT Filed: May 30, 2023
(86) PCT No.: PCT/JP2023/020065

§ 371 Date: Nov. 20, 2025

(51) Int. Cl. B23Q 1/54

(52) U.S. Cl. CPC B23Q 1/5437; B23Q 2220/004

(57) ABSTRACT

This biaxial rotary table device comprises: a first table unit that has a first rotating body which can rotate about a first axis; a second table unit that has a second rotating body which can rotate about a second axis; a connecting plate that is fixed to the first rotating body and that supports the second table unit; a first fine adjustment member that is provided to the second table unit or the connecting plate and that relatively displaces the second table unit, in a first direction, with respect to the first table unit; and a second fine adjustment member that is provided to the second table unit or the connecting plate and that relatively displaces the second table unit, in a second direction, with respect to the first table unit.

### TECHNICAL FIELD

The present disclosure relates to a two-axis rotary table device (biaxial rotary table device) that rotates a workpiece about two axes, and a machine tool including the two-axis rotary table device.

### BACKGROUND ART

A machine tool such as a machining center moves a workpiece and a tool relative to each other along three linear axes. Further, a two-axis rotary table device is provided which enables five-axis machining by the machine tool. A machine tool including a two-axis rotary table device can tilt a workpiece about a tilting axis and can rotate the workpiece about a rotary axis. For example, JP 2015-062973 A discloses a machine tool including a two-axis rotary table device.

### SUMMARY OF THE INVENTION

There has been a demand for a two-axis rotary table device and a machine tool for suitably performing five-axis control.

A two-axis rotary table device of the present disclosure comprises: a first table unit including a first rotating body rotatable about a first axis; a second table unit including a second rotating body rotatable about a second axis; a connecting plate fixed to the first rotating body of the first table unit and configured to support the second table unit; a first fine adjustment member provided at the second table unit or the connecting plate and configured to displace the second table unit relative to the first table unit in a first direction orthogonal to the first axis and the second axis; and a second fine adjustment member provided at the second table unit or the connecting plate and configured to displace the second table unit relative to the first table unit in a second direction that is opposite to the first direction.

A machine tool according to the present disclosure is a machine tool to and from which the two-axis rotary table device according to the above disclosure is attachable and detachable, the machine tool comprising three linear axes orthogonal to each other.

### BRIEF DESCRIPTION OF DRAWINGS

FIG. 1 is a schematic view of a machine tool;

FIG. 2 is a schematic view of a two-axis rotary table device;

FIG. 3 is a schematic view of the two-axis rotary table device in a state where a second table unit is separated;

FIG. 4 is a diagram showing the relative positions of a first axis and a second axis;

FIG. 5 is a schematic view of the second table unit;

FIG. 6 is a schematic view of a first connecting plate; and

FIG. 7A and FIG. 7B are partial cross-sectional views of the first connecting plate.

### DETAILED DESCRIPTION OF THE INVENTION

### Machine Tool 10

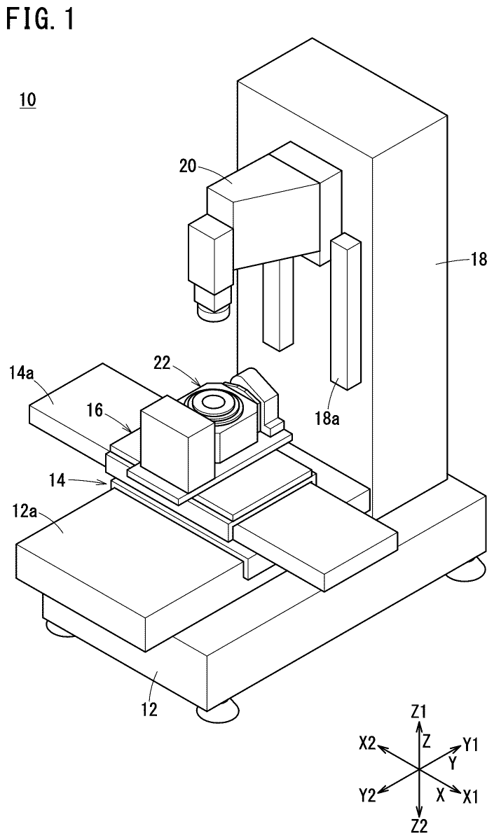

FIG. 1 is a schematic view of a machine tool 10. In the following, the machine tool 10 will be described using three directions, namely, an X direction, a Y direction, and a Z direction. The X direction, the Y direction, and the Z direction are orthogonal to each other. The X direction includes an X1 direction and an X2 direction opposite to each other. The Y direction includes a Y1 direction and a Y2 direction opposite to each other. The Z direction includes a Z1 direction and a Z2 direction opposite to each other.

The machine tool 10 has three linear axes that are orthogonal to each other. The three linear axes are defined as an X-axis, a Y-axis, and a Z-axis. The X-axis extends along the X direction. The Y-axis extends along the Y direction. The Z-axis extends along the Z direction. For example, the X-axis and the Y-axis are parallel to a horizontal plane. The Z-axis is parallel to a vertical plane.

The machine tool 10 functions as a machining center. The machine tool 10 includes a base 12, a saddle 14, a table 16, a column 18, and a spindle head 20. The base 12 includes a guide portion 12a. The guide portion 12a is parallel to the Y-axis.

The saddle 14 is attached to the base 12. The saddle 14 is movable in the Y1 direction and the Y2 direction along the Y-axis by being guided by the guide portion 12a. The saddle 14 includes a guide portion 14a. The guide portion 14a is parallel to the X-axis. The table 16 is attached to the saddle 14. The table 16 is movable in the X1 direction and the X2 direction along the X-axis by being guided by the guide portion 14a. The column 18 extends in the Z1 direction from the base 12. The column 18 includes a guide portion 18a. The guide portion 18a is parallel to the Z-axis. The spindle head 20 is attached to the column 18. The spindle head 20 is movable in the Z1 direction and the Z2 direction along the Z-axis by being guided by the guide portion 18a.

A two-axis rotary table device 22 is attachable to and detachable from the table 16. A workpiece (not shown), which is an object to be machined, is fixed to the two-axis rotary table device 22. On the other hand, a tool (not shown) is attachable to and detachable from the spindle head 20. The workpiece and the tool face each other.

### Two-Axis Rotary Table Device 22

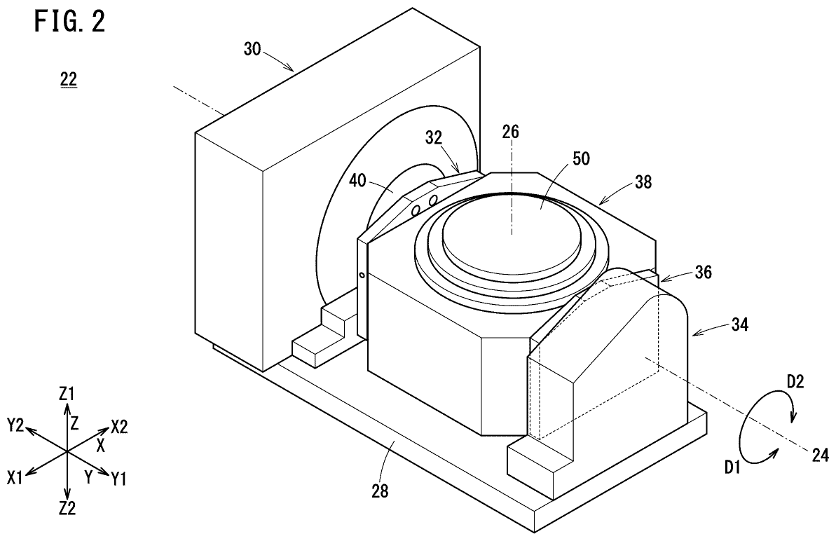

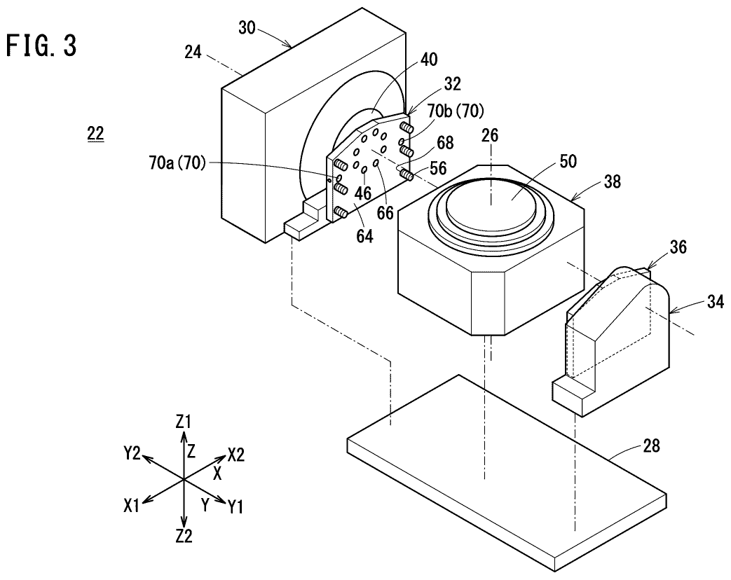

FIG. 2 is a schematic view of the two-axis rotary table device 22. FIG. 3 is a schematic view of the two-axis rotary table device 22 in a state where a second table unit 38 is separated. The two-axis rotary table device 22 has two rotary axes. The two rotary axes are defined as a first axis 24 and a second axis 26. The first axis 24 extends along the Y direction. The first axis 24 is a tilting axis for swinging (tilting) the workpiece on the table 16. The second axis 26 is rotatable about the first axis 24. The second axis 26 is parallel to an XZ plane. The XZ plane is a virtual plane parallel to the X direction and the Z direction and orthogonal to the Y direction.

The two-axis rotary table device 22 includes a base portion 28, a first table unit 30, a first connecting plate 32, a support member 34, a second connecting plate 36, and the second table unit 38. The two-axis rotary table device 22 includes the first table unit 30 and the second table unit 38 each of which can be used as a single-axis table section.

The base portion 28 is attachable to and detachable from the table 16 of the machine tool 10 (FIG. 1). The base portion 28 supports the first table unit 30 and the support member 34.

The first table unit 30 is fixed to the base portion 28. The first table unit 30 includes a motor (not shown) and a first rotary table 40 (a first rotating body). The motor supplies motive power to the first rotary table 40. The first rotary table 40 is rotatable about the first axis 24 by the motive power supplied from the motor.

As described above, the first table unit 30 can also be used as a single-axis table section. For example, a holder that holds a workpiece may be attached to the first rotary table 40. As a result, the first table unit 30 can rotate (tilt) the workpiece about the first axis 24.

The first connecting plate 32 is fastened to the first rotary table 40 by a plurality of bolts 46 (FIG. 3). As a result, the first connecting plate 32 can rotate about the first axis 24 together with the first rotary table 40.

The support member 34 is fixed to the base portion 28. The support member 34 is disposed in the Y1 direction with respect to the first table unit 30. The support member 34 includes a support rotary table (not shown). The support rotary table is rotatable about the first axis 24.

The second connecting plate 36 has the same structure as the first connecting plate 32. Specifically, the second connecting plate 36 is fastened to the support rotary table by a plurality of socket head bolts (not shown). As a result, the second connecting plate 36 can rotate about the first axis 24 together with the support rotary table.

The second table unit 38 is disposed on the first axis 24 between the first connecting plate 32 and the second connecting plate 36. In other words, the second table unit 38 is disposed in the Y1 direction with respect to the first table unit 30 and the first connecting plate 32, and is disposed in the Y2 direction with respect to the support member 34 and the second connecting plate 36. The second table unit 38 is fastened to the first connecting plate 32 by a plurality of (six in FIG. 3) bolts 56 (fastening members). Similarly, the second table unit 38 is fastened to the second connecting plate 36 by a plurality of bolts (not shown). As a result, the second table unit 38 is supported so as to be swingable about the first axis 24 by a first support unit including the first table unit 30 and the first connecting plate 32, and a second support unit including the support member 34 and the second connecting plate 36.

The second table unit 38 includes a motor (not shown) and a second rotary table 50 (a second rotating body). The motor supplies motive power to the second rotary table 50. The second rotary table 50 is rotatable about the second axis 26 by the motive power supplied from the motor. A workpiece is fixed to the second rotary table 50.

The second table unit 38 is swingable about the first axis 24. That is, the second axis 26 can be parallel to the Z direction, and can also be tilted to one side and the other side with respect to the Z direction along the XZ plane.

### Deviation of Second Axis 26 from First Axis 24

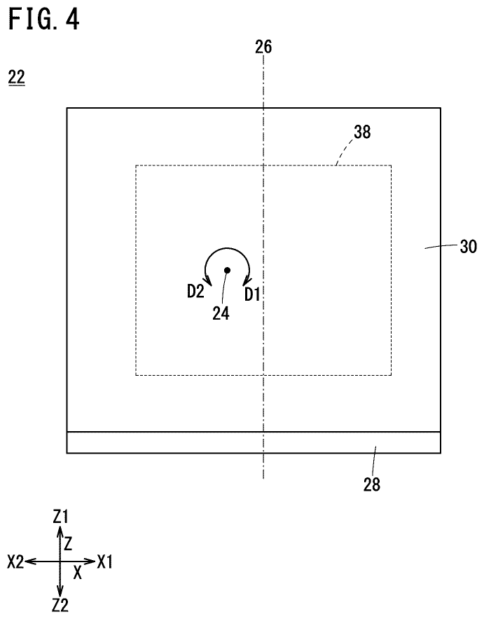

FIG. 4 is a diagram showing the relative positions of the first axis 24 and the second axis 26. FIG. 4 shows the two-axis rotary table device 22 as viewed in the Y1 direction. In the two-axis rotary table device 22, after the first table unit 30 and the second table unit 38 are combined, the second axis 26 may be deviated in the X1 direction or the X2 direction from the first axis 24. Although the amount of deviation that occurs is very small, the amount of deviation is shown in an exaggerated manner in FIG. 4.

In the case where the second axis 26 is deviated from the first axis 24 in the X1 direction or the X2 direction, the following event occurs. For example, as shown in FIG. 4, the posture of the second table unit 38 in a state where the second axis 26 is parallel to the Z-axis (the Z direction) is referred to as a reference posture. The second table unit 38 is swingable about the first axis 24 in a first swinging direction (DI) and a second swinging direction (D2) from the reference posture. The first swinging direction (D1) and the second swinging direction (D2) are opposite to each other. The trajectory of the second axis 26 in the case where the second table unit 38 swings in the first swinging direction (D1) from the reference posture is asymmetric to the trajectory of the second axis 26 in the case where the second table unit 38 swings in the second swinging direction (D2) from the reference posture.

In the case where the second axis 26 is deviated from the first axis 24, the machine tool 10 needs to compensate for the deviation by NC control. By bringing the second axis 26 close to the first axis 24 in advance after the first table unit 30 and the second table unit 38 are combined, the amount of compensation for the deviation by the NC control can be reduced. Furthermore, by making the second axis 26 orthogonal to the first axis 24, the compensation for the deviation by the NC control becomes unnecessary.

### Structure for Reducing Deviation of Second Axis 26 from First Axis 24

Hereinafter, the first connecting plate 32 and the second table unit 38 will be further described, and a structure for reducing the deviation of the second axis 26 from the first axis 24 will be described.

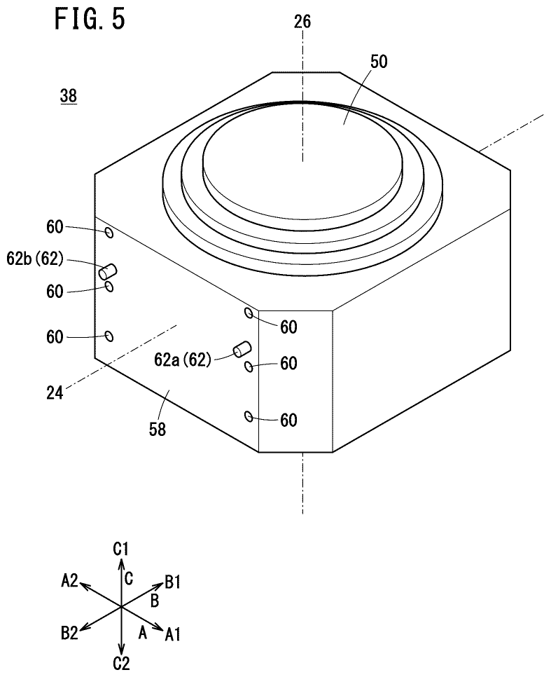

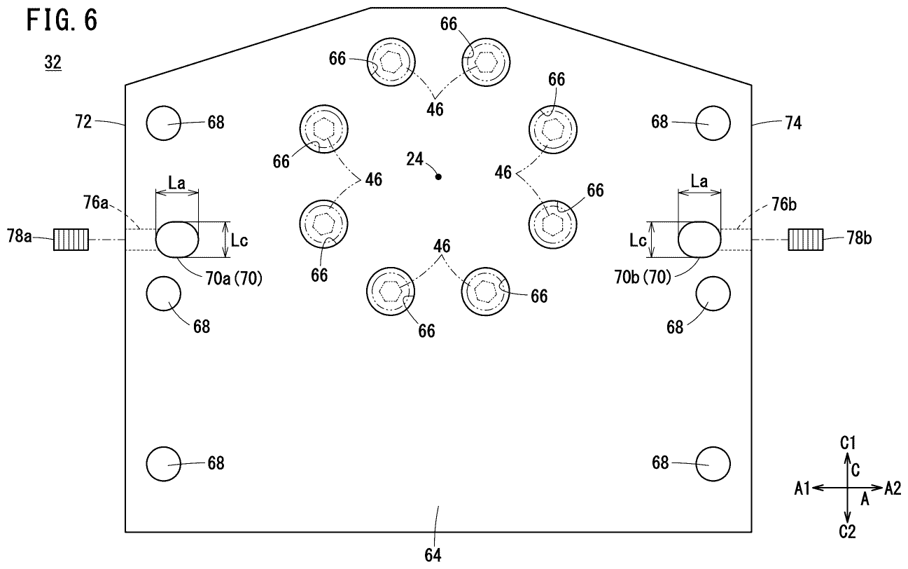

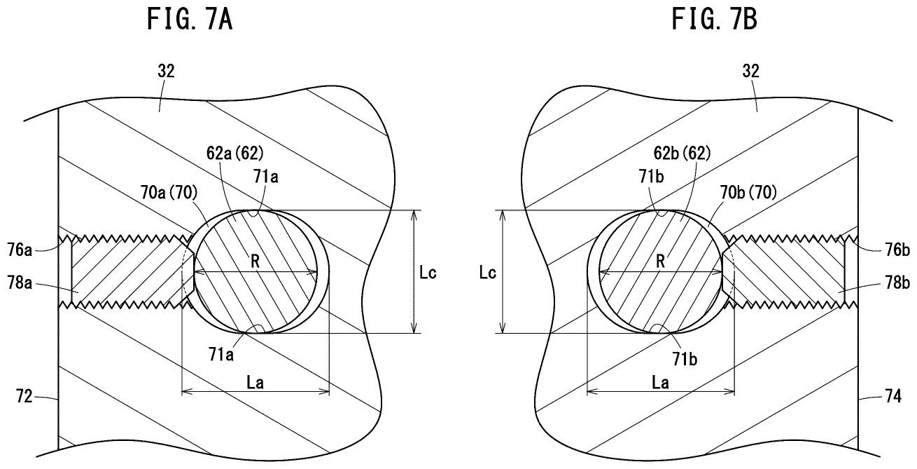

FIG. 5 is a schematic view of the second table unit 38. FIG. 6 is a schematic view of the first connecting plate 32. FIGS. 7A and 7B are partial cross-sectional views of the first connecting plate 32. FIGS. 7A and 7B show partial cross sections parallel to an AC plane. In the following, the first connecting plate 32 and the second table unit 38 will be described using three directions, namely, an A direction, a B direction, and a C direction. The A direction, the B direction, and the C direction are orthogonal to each other. The A direction includes an A1 direction (a first direction) and an A2 direction (a second direction) opposite to each other. The B direction includes a B1 direction and a B2 direction opposite to each other. The C direction includes a C1 direction and a C2 direction opposite to each other. The B direction is parallel to the Y direction shown in FIGS. 1 to 4. The first axis 24 is orthogonal to the A direction and the C direction, and extends along the B direction. The second axis 26 is orthogonal to the A direction and the B direction, and extends along the C direction.

As shown in FIG. 5, the second table unit 38 includes an attachment surface 58 facing the first connecting plate 32. The attachment surface 58 is provided with a protruding portion 62 and a plurality of bolt holes 60. The protruding portion 62 includes a first pin 62a and a second pin 62b. The protruding direction of the first pin 62a and the protruding direction of the second pin 62b are parallel to the B direction. That is, the first pin 62a and the second pin 62b protrude along the first axis 24. The first pin 62a and the second pin 62b have a circular columnar shape. In the C direction, the position of the first pin 62a is the same as the position of the second pin 62b. The first pin 62a is disposed in the Al direction with respect to the first axis 24. The second pin 62b is disposed in the A2 direction with respect to the first axis 24.

As shown in FIG. 6, the first connecting plate 32 includes an attachment surface 64 facing the second table unit 38. The A direction and the C direction are orthogonal to the thickness direction of the first connecting plate 32. The B direction is parallel to the thickness direction of the first connecting plate 32. A hole portion 70, a plurality of first through holes 66, and a plurality of second through holes 68 are formed in the attachment surface 64. Each of the first through holes 66 and each of the second through holes 68 penetrate the first connecting plate 32 along the B direction. The diameter of the second through holes 68 is slightly larger than the diameter of the bolts 56. Accordingly, the bolts 56 can be displaced in the A direction in a state where the bolts 56 are temporarily fastened to the second through holes 68.

The bolts 46 are inserted into the first through holes 66 of the first connecting plate 32 toward the B2 direction (the Y2 direction). Further, the bolts 46 are screwed into bolt holes (not shown) formed in the first rotary table 40. The first connecting plate 32 and the first rotary table 40 are fastened to each other by the bolts 46.

As shown in FIG. 3, the bolts 56 are inserted into the second through holes 68 of the first connecting plate 32 toward the B1 direction (the Y1 direction). Further, the bolts 56 are screwed into the bolt holes 60 formed in the attachment surface 58 of the second table unit 38. The first connecting plate 32 and the second table unit 38 are fastened to each other by the bolts 56.

As shown in FIG. 6, the hole portion 70 includes a first hole 70a and a second hole 70b. The first hole 70a and the second hole 70b are open in the B1 direction (the Y1 direction). The depth direction of the first hole 70a and the depth direction of the second hole 70b are parallel to the B direction. That is, the depth direction of the first hole 70a and the depth direction of the second hole 70b are parallel to the first axis 24. In the C direction, the position of the first hole 70a is the same as the position of the second hole 70b. The first hole 70a is disposed in the Al direction with respect to the first axis 24. The second hole 70b is disposed in the A2 direction with respect to the first axis 24.

As shown in FIG. 6, the first hole 70a has an oval shape that is elongated in the A direction. That is, a length (La) of the first hole 70a in the A direction is greater than a length (Lc) of the first hole 70a in the C direction. Similarly, the second hole 70b has an oval shape that is elongated in the A direction. That is, a length (La) of the second hole 70b in the A direction is greater than a length (Lc) of the second hole 70b in the C direction. As shown in FIG. 7A, the length (Lc) of the first hole 70a in the C direction is substantially the same as an outer diameter (R) of the first pin 62a. As shown in FIG. 7B, the length (Lc) of the second hole 70b in the C direction is substantially the same as an outer diameter (R) of the second pin 62b.

A pair of flat surface portions 71a parallel to the A direction are formed on the inner wall of the first hole 70a. Similarly, a pair of flat surface portions 71b parallel to the A direction are formed on the inner wall of the second hole 70b. The length of the flat surface portions 71a in the A direction is the same as the length of the flat surface portions 71b in the A direction. The protruding portion 62 (the first pin 62a and the second pin 62b) is displaceable within the range of this length.

The first pin 62a of the second table unit 38 is inserted into the first hole 70a toward the B2 direction. The second pin 62b of the second table unit 38 is inserted into the second hole 70b toward the B2 direction. As shown in FIG. 7A, in a state where the first pin 62a is inserted into the first hole 70a, the displacement of the first pin 62a in the C direction is restricted by the pair of flat surface portions 71a, while the displacement of the first pin 62a in the A direction is allowed. Similarly, as shown in FIG. 7B, in a state where the second pin 62b is inserted into the second hole 70b, the displacement of the second pin 62b in the C direction is restricted by the pair of flat surface portions 71b, while the displacement of the second pin 62b in the A direction is allowed. That is, in a state where the protruding portion 62 is inserted into the hole portion 70, the displacement of the second table unit 38 in the C direction is restricted, while the displacement of the second table unit 38 in the A direction is allowed.

As shown in FIG. 6 and FIG. 7A, an opening of a first screw hole 76a is formed in a first side surface 72 of the first connecting plate 32 that faces in the Al direction. The first screw hole 76a extends from the first side surface 72 to the first hole 70a along the A direction. A first screw member 78a is screwed into the first screw hole 76a. An end portion of the first screw member 78a in the A2 direction abuts against the first pin 62a inserted into the first hole 70a. When the first screw member 78a is displaced in the A2 direction, the first pin 62a is pushed by the first screw member 78a and is displaced in the A2 direction. In addition, in a state where the first screw member 78a is stopped, the first screw member 78a restricts displacement of the first pin 62a in the A1 direction.

As shown in FIG. 6 and FIG. 7B, an opening of a second screw hole 76b is formed in a second side surface 74 of the first connecting plate 32 that faces in the A2 direction. The second screw hole 76b extends from the second side surface 74 to the second hole 70b along the A direction. A second screw member 78b is screwed into the second screw hole 76b. An end portion of the second screw member 78b in the A1 direction abuts against the second pin 62b inserted into the second hole 70b. When the second screw member 78b is displaced in the A1 direction, the second pin 62b is pushed by the second screw member 78b and is displaced in the A1 direction. In addition, in a state where the second screw member 78b is stopped, the second screw member 78b restricts displacement of the second pin 62b in the A2 direction.

The first screw member 78a is a fine adjustment member that converts the amount of rotation given to the first screw member 78a into the amount of axial displacement of the first screw member 78a to finely adjust the position of the first pin 62a. Similarly, the second screw member 78b is a fine adjustment member that converts the amount of rotation given to the second screw member 78b into the amount of axial displacement of the second screw member 78b to finely adjust the position of the second pin 62b.

### Adjustment of Deviation of Second Axis 26 from First Axis 24

First, the two-axis rotary table device 22 is temporarily assembled as the state shown in FIG. 3. That is, the plurality of bolts 56 (FIG. 3) fastening the second table unit 38 and the first connecting plate 32 are temporarily tightened. Similarly, the plurality of bolts (not shown) fastening the second table unit 38 and the second connecting plate 36 are temporarily tightened. In this state, the second axis 26 is made parallel to the Z direction as shown in FIG. 4, for example. Then, the X direction shown in FIG. 3 and the A direction shown in FIG. 4 and the like become parallel to each other. In this state, the amount of protrusion of the first screw member 78a in the first screw hole 76a and the amount of protrusion of the second screw member 78b in the second screw hole 76b are adjusted according to the direction of the deviation of the second axis 26 from the first axis 24.

For example, as shown in FIG. 4, in the case where the second axis 26 is deviated in the X1 direction (the A1 direction), the second screw member 78b (FIG. 7B) is loosened. As a result, the second pin 62b can be displaced in the X2 direction (the A2 direction) in the second screw hole 76b. That is, the second table unit 38 can be displaced in the X2 direction (the A2 direction). Next, the first screw member 78a (FIG. 7A) is tightened. As a result, the first screw member 78a pushes the first pin 62a in the X2 direction (the A2 direction). Then, the second table unit 38 is displaced in the X2 direction (the A2 direction). In the case where the amount of deviation of the second axis 26 from the first axis 24 becomes equal to or less than an allowable amount (preferably, in the case where the first axis 24 and the second axis 26 are orthogonal to each other), the second screw member 78b is tightened. As a result, the position of the second table unit 38 in the X direction (the A direction) is determined.

For example, unlike FIG. 4, in the case where the second axis 26 is deviated in the X2 direction (the A2 direction), the first screw member 78a (FIG. 7A) is loosened. As a result, the first pin 62a can be displaced in the X1 direction (the A1 direction) in the first screw hole 76a. That is, the second table unit 38 can be displaced in the X1 direction (the A1 direction). Next, the second screw member 78b (FIG. 7B) is tightened. As a result, the second screw member 78b pushes the second pin 62b in the X1 direction (the A1 direction). Then, the second table unit 38 is displaced in the X1 direction (the A1 direction). In the case where the amount of deviation of the second axis 26 from the first axis 24 becomes equal to or less than an allowable amount (preferably, in the case where the first axis 24 and the second axis 26 are orthogonal to each other), the first screw member 78a is tightened. As a result, the position of the second table unit 38 in the X direction (the A direction) is determined.

The second connecting plate 36 has the same structure as the first connecting plate 32. The second connecting plate 36 is also provided with screw members equivalent to the first screw member 78a and the second screw member 78b. The position of the second table unit 38 in the X direction (the A direction) is determined by adjusting the positions of these screw members.

Finally, the plurality of bolts 56 fastening the second table unit 38 and the first connecting plate 32 are fully tightened. Similarly, the plurality of bolts (not shown) fastening the second table unit 38 and the second connecting plate 36 are fully tightened. By the above operation, the first axis 24 and the second axis 26 can be brought close to each other (orthogonal to each other).

### Effects of the Above Embodiment

In the case where the first table unit 30 and the second table unit 38, each of which can be used as a single-axis table section, are combined to form the two-axis rotary table device 22, it is necessary to adjust the position of the second axis 26 with respect to the first axis 24. According to the above embodiment, the second table unit 38 can be displaced along the A direction by the first screw member 78a and the second screw member 78b. Further, the first screw member 78a and the second screw member 78b make it easy to finely adjust the displacement amount. Therefore, the position arrangement of the second axis 26 can be easily performed with high accuracy.

According to the above embodiment, the second axis 26 can be brought close to the first axis 24 after the first table unit 30 and the second table unit 38 are combined. This makes it possible to reduce the amount of compensation for the deviation by the NC control. Furthermore, by making the second axis 26 orthogonal to the first axis 24, the compensation for the deviation by the NC control becomes unnecessary. As a result, the five-axis control by the machine tool 10 can be suitably performed.

According to the above embodiment, the first pin 62a is displaceable by the length (La) of the first hole 70a in the A direction. Similarly, the second pin 62b is displaceable by the length (La) of the second hole 70b in the A direction. That is, the position of the second table unit 38 is adjustable within the range of the length (La).

According to the above embodiment, the displacement of the first pin 62a in the C direction is restricted by the inner wall of the first hole 70a. Similarly, the displacement of the second pin 62b in the C direction is restricted by the inner wall of the second hole 70b. Therefore, when the deviation of the second axis 26 from the first axis 24 is adjusted, the second table unit 38 can be prevented from being displaced in the C direction.

### Modification

The machine tool 10 shown in FIG. 1 moves a workpiece along the X-axis and the Y-axis, and moves a tool along the Z-axis.

However, the machine tool 10 of the present disclosure is not limited to this feature. The machine tool 10 may have any structure as long as the tool and the workpiece can be relatively displaced along the X-axis, the Y-axis, and the Z-axis.

In the above-described two-axis rotary table device 22, the protruding portion 62 (the first pin 62a and the second pin 62b) is formed in the second table unit 38, and the hole portion 70 (the first hole 70a and the second hole 70b) is formed in the first connecting plate 32. However, the protruding portion 62 (the first pin 62a and the second pin 62b) may be formed in the first connecting plate 32, and the hole portion 70 (the first hole 70a and the second hole 70b) may be formed in the second table unit 38. Similarly, the second connecting plate 36 may include the protruding portion, and the second table unit 38 may include the hole portion.

The above-described two-axis rotary table device 22 includes the two pins (the first pin 62a and the second pin 62b) and the two holes (the first hole 70a and the second hole 70b). However, the two-axis rotary table device 22 may include one or three or more pin members, and one or three or more holes. In the case where the number of pins and the number of holes are both one, the first screw hole 76a and the second screw hole 76b communicate with one hole. Further, the first screw member 78a and the second screw member 78b abut against one pin.

In the above-described two-axis rotary table device 22, one pin (the first pin 62a or the second pin 62b) is inserted into one hole (the first hole 70a or the second hole 70b). However, one of the holes (the first hole 70a or the second hole 70b) may be one hole that is elongated in the A direction, and one pin may be inserted into the end portion of the hole in the A1 direction, and the other pin may be inserted into the end portion of the hole in the A2 direction.

The protruding direction of the protruding portion 62 and the depth direction of the hole portion 70 may not be the Y direction. For example, the protruding portion 62 may be an L-shaped pin having a portion parallel to the Z direction. In this case, the depth direction of the hole portion 70 is parallel to the Z direction.

The protruding portion 62 may be a member other than a pin. For example, the protruding portion 62 may be a protrusion having any shape that protrudes from the attachment surface 58 of the second table unit 38.

In the above-described two-axis rotary table device 22, the second table unit 38 is sandwiched and held so as to be swingable about the first axis 24 by a holding unit including the first table unit 30 and the first connecting plate 32 and a holding unit including the support member 34 and the second connecting plate 36. However, the two-axis rotary table device 22 of the present disclosure is not limited to this feature. For example, the two-axis rotary table device 22 may not include the support member 34 and the second connecting plate 36. That is, the two-axis rotary table device 22 may be supported so as to be rotatable about the first axis 24 by the holding unit including the first table unit 30 and the first connecting plate 32.

### Effects of the Above Disclosure

In the case where the first table unit 30 and the second table unit 38, each of which can be used as a single-axis table section, are combined to form the two-axis rotary table device 22, it is necessary to adjust the position of the second axis 26 with respect to the first axis 24. According to the above embodiment, the second table unit 38 can be displaced along the A direction by the first screw member 78a and the second screw member 78b. Further, the first screw member 78a and the second screw member 78b make it easy to finely adjust the displacement amount. Therefore, the position arrangement of the second axis 26 can be easily performed with high accuracy.

According to the above embodiment, the second axis 26 can be brought close to the first axis 24 after the first table unit 30 and the second table unit 38 are combined. This makes it possible to reduce the amount of compensation for the deviation by the NC control. Furthermore, by making the second axis 26 orthogonal to the first axis 24, the compensation for the deviation by the NC control becomes unnecessary. As a result, the five-axis control by the machine tool 10 can be suitably performed.

### Other Embodiments

In the above embodiment, the first screw member 78a and the second screw member 78b are used as the fine adjustment members. Note that, as the fine adjustment member, a member other than the first screw member 78a and the second screw member 78b may be provided in the second table unit 38 or the first connecting plate 32 (the second connecting plate 36). The fine adjustment member may be any member as long as it converts the input amount into a smaller displacement amount. For example, the fine adjustment member may be a wedge having a taper angle.

The fine adjustment member may be a mechanism that has a fulcrum, a point of effort, and a point of action, and converts the input amount into a smaller displacement amount by changing the distance between the points. For example, the fine adjustment member may be a mechanism including a lever, a cam, or the like.

The fine adjustment member may be a vibration generator (such as an ultrasonic motor) that generates minute vibration.

For example, some member may push the second table unit 38 while reducing the frictional force between the first connecting plate 32 and the second table unit 38 by the vibration generated by the vibration generator. Alternatively, the second table unit 38 may be displaced with respect to the first connecting plate 32 by minute vibration generated by the vibration generator.

### Supplementary Note

The following supplementary notes are further disclosed in relation to the above-described embodiments and modification.

### Supplementary Note 1

The two-axis rotary table device (22) includes: the first table unit (30) including the first rotating body (40) rotatable about the first axis (24); the second table unit (38) including the second rotating body (50) rotatable about the second axis (26) ; the connecting plate (32) fixed to the first rotating body of the first table unit and configured to support the second table unit; the first fine adjustment member (78a) provided at the second table unit or the connecting plate and configured to displace the second table unit relative to the first table unit in the first direction orthogonal to the first axis and the second axis; and the second fine adjustment member (78b) provided at the second table unit or the connecting plate and configured to displace the second table unit relative to the first table unit in the second direction that is opposite to the first direction.

### Supplementary Note 2

In the two-axis rotary table device according to Supplementary Note 1, the first fine adjustment member may be the first screw member screwed to the second table unit or the connecting plate, and the second fine adjustment member may be the second screw member screwed to the second table unit or the connecting plate.

### Supplementary Note 3

In the two-axis rotary table device according to Supplementary Note 2, one of the connecting plate or the second table unit may include the hole portion (70), another one of the connecting plate or the second table unit may includes the protruding portion (62) inserted into the hole portion, and the length (La) of the hole portion in the first direction and the second direction may be greater than the length (R) of the protruding portion in the first direction and the second direction.

### Supplementary Note 4

In the two-axis rotary table device according to Supplementary Note 3, the connecting plate may include the hole portion, and the second table unit may include the protruding portion.

### Supplementary Note 5

In the two-axis rotary table device according to Supplementary Note 3 or 4, in the hole portion, the first screw member and the second screw member may push the protruding portion.

### Supplementary Note 6

In the two-axis rotary table device according to any one of Supplementary Notes 2 to 5, the first screw member and the second screw member may be screwed to the connecting plate.

### Supplementary Note 7

In the two-axis rotary table device according to Supplementary Note 3 or 4, the hole portion may include the first hole (70a) and the second hole (70b), and the protruding portion may include the first pin (62a) inserted into the first hole, and the second pin (62b) inserted into the second hole.

### Supplementary Note 8

In the two-axis rotary table device according to Supplementary Note 7, the first pin and the second pin may protrude along the first axis.

### Supplementary Note 9

In the two-axis rotary table device according to Supplementary Note 7 or 8, the position of the first pin may be the same as the position of the second pin in the second axis direction parallel to the second axis.

### Supplementary Note 10

In the two-axis rotary table device according to any one of Supplementary Notes 7 to 9, the connecting plate may include the first hole, the second hole, the first screw hole (76a) extending from the first side surface (72) of the connecting plate to the first hole, and the second screw hole (76b) extending from the second side surface (74) of the connecting plate to the second hole, the first screw member may be screwed into the first screw hole, and the second screw member may be screwed into the second screw hole.

### Supplementary Note 11

In the two-axis rotary table device according to any one of Supplementary Notes 1 to 10, the second table unit and the connecting plate may be detachably fastened to each other by a fastening member (56).

### Supplementary Note 12

The machine tool (10), to and from which the two-axis rotary table device according to any one of Supplementary Notes 1 to 11 is attachable and detachable, includes three linear axes orthogonal to each other.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

### REFERENCE SIGNS LIST

10: machine tool
22: two-axis rotary table device
24: first axis
26: second axis
30: first table unit
32: first connecting plate (connecting plate)
38: second table unit
40: first rotary table (first rotating body)
50: second rotary table (second rotating body)
56: bolt (fastening member)
62: protruding portion
62a: first pin
62b: second pin
70: hole portion
70a: first hole
70b: second hole
72: first side surface
74: second side surface
76a: first screw hole
76b: second screw hole
78a: first screw member (first fine adjustment member)
78b: second screw member (second fine adjustment member)

1. A two-axis rotary table device, comprising:
a first table unit including a first rotating body rotatable about a first axis;
a second table unit including a second rotating body rotatable about a second axis;
a connecting plate fixed to the first rotating body of the first table unit and configured to support the second table unit;
a first fine adjustment member provided at the second table unit or the connecting plate and configured to displace the second table unit relative to the first table unit in a first direction orthogonal to the first axis and the second axis; and
a second fine adjustment member provided at the second table unit or the connecting plate and configured to displace the second table unit relative to the first table unit in a second direction that is opposite to the first direction.

2. The two-axis rotary table device according to claim 1, wherein
the first fine adjustment member is a first screw member screwed to the second table unit or the connecting plate, and
the second fine adjustment member is a second screw member screwed to the second table unit or the connecting plate.

3. The two-axis rotary table device according to claim 2, wherein
one of the connecting plate or the second table unit includes a hole portion,
another one of the connecting plate or the second table unit includes a protruding portion inserted into the hole portion, and
a length of the hole portion in the first direction and the second direction is greater than a length of the protruding portion in the first direction and the second direction.

4. The two-axis rotary table device according to claim 3, wherein
the connecting plate includes the hole portion, and
the second table unit includes the protruding portion.

5. The two-axis rotary table device according to claim 3, wherein
in the hole portion, the first screw member and the second screw member push the protruding portion.

6. The two-axis rotary table device according to claim 2, wherein
the first screw member and the second screw member are screwed to the connecting plate.

7. The two-axis rotary table device according to claim 3, 4, wherein
the hole portion includes a first hole and a second hole, and
the protruding portion includes a first pin inserted into the first hole, and a second pin inserted into the second hole.

8. The two-axis rotary table device according to claim 7, wherein
the first pin and the second pin protrude along the first axis.

9. The two-axis rotary table device according to claim 7, wherein
a position of the first pin is same as a position of the second pin in a second axis direction that is parallel to the second axis.

10. The two-axis rotary table device according to claim 7, wherein
the connecting plate includes the first hole, the second hole, a first screw hole extending from a first side surface of the connecting plate to the first hole, and a second screw hole extending from a second side surface of the connecting plate to the second hole,
the first screw member is screwed into the first screw hole, and
the second screw member is screwed into the second screw hole.

11. The two-axis rotary table device according to claim 1, wherein
the second table unit and the connecting plate are detachably fastened to each other by a fastening member.

12. A machine tool to and from which the two-axis rotary table device according to claim 1 is attachable and detachable, the machine tool comprising three linear axes orthogonal to each other.
